(19) United States
(12) Patent Application Publication
(10) Pub. No.: US 2007/0236468 A1
(43) Pub. Date: Oct. 11, 2007

(54) Gesture based device activation

(76) Inventor: Apaar Tuli, Tampere (FI)

Correspondence Address: PERMAN & GREEN, 425 POST ROAD, FAIRFIELD, CT, 06824, US

(21) Appl. No.: 11/394,383

(22) Filed: Mar. 30, 2006

(51) Int. Cl. G06F 3/041

(52) U.S. Cl. 345/173

(57) ABSTRACT

A method of device feature activation is provided. The method includes detecting a mark made by an input device on a touch enabled screen of the device, displaying at least one command to at least one feature available to be selected on the screen in response to a detection of the mark and activating the at least one feature upon detecting that the mark has been extended into a region of the screen where the at least one command is displayed.

### BACKGROUND

1. Field

The disclosed embodiments relate to user interfaces for touch screen devices and, more particularly, to activating device features through the touch screen of the device.

2. Brief Description of Related Developments

For optimal interaction with a touch screen device, all actions should be possible using either the keyboard of the device or the pointing device. The user of the device should not have to unnecessarily switch between the two input methods and break the task flow. The point at which the user must switch from using the pointing device to the keyboard is referred to herein as the “pen threshold”. Most tasks in a device should be possible without having to cross the pen threshold so that the task flow is not broken when a user starts a task using the pointing device.

There is no quick and easy way to access various device features such as, for example, software functions, lights or speakers using conventional systems. In some conventional touch screen devices not all actions or software functions are easily accessed using the pointing device. These functions are only accessible through a complicated and time-consuming interaction using the pointing device or are otherwise accessed via the keyboard. In other conventional devices some of the software functions may not be accessible at all when using the pointing device.

It would be advantageous to be able to access and activate features of a device through movements or gestures made on the touch screen display.

### SUMMARY

In one exemplary embodiment, a method to activate features of a device is provided. The method includes detecting a mark made by an input device on a touch enabled screen of the device, displaying at least one command to at least one selectable feature in a region of the screen in response to the detection of the mark and activating the at least one feature upon detecting that the mark has been extended into the region of the screen where the at least one command is displayed.

In another aspect, a method for activating functions with a pointing device on a device having a touch screen is provided. The method includes placing the pointing device substantially in contact with a touch screen at a first region of the touch screen, forming a first mark on the touch screen with the pointing device, automatically displaying at least one feature command of the device upon detection of the first mark, forming a second mark on the touch screen wherein an end point of the second mark is substantially in a second region of the touch screen and automatically activating a selected function upon detection of the end point of the second mark.

In an another exemplary embodiment, a device is provided. The device includes a display processor, a touch enabled screen coupled to the display processor, an input detection unit coupled to the display processor that is configured to receive an input in the form of a mark made by an input device on the touch enabled screen, an input recognition unit coupled to the display processor that is configured to detect an origin of the mark and an end of the mark and a feature engagement unit coupled to the display processor configured to present at least one command to at least one feature on the screen and activate a selected one of the at least one feature.

In one exemplary embodiment a computer program product is provided. A computer program product includes a computer useable medium having a computer readable code means embodied therein for causing a computer activate a feature of a touch screen device. The computer readable program code means in the computer program product includes computer readable program code means for causing a computer to form a mark as defined with a pointing device on a touch screen, the mark originating in a corner region of the touch screen and passing through a center region of the touch screen. Computer readable program code means for causing the computer to automatically display at least one command to at least one feature of the device and computer readable program code means for causing a computer to activate at least one feature of the device corresponding to a selected one of the at least one command, wherein the selected one of the at least one command is selected by extending the mark into a region of the screen where the at least one command is displayed.

### BRIEF DESCRIPTION OF THE DRAWINGS

The foregoing aspects and other features of the present invention are explained in the following description, taken in connection with the accompanying drawings, wherein:

FIG. 1 shows a device incorporating features of an exemplary embodiment;

FIGS. 2A and 2B show state changes of the graphical user interface in accordance with an exemplary embodiment;

FIG. 3 shows an exemplary graphic user interface gesture made in accordance with an one embodiment;

FIG. 4 shows an indicator for an activated device function in accordance with an exemplary embodiment;

FIGS. 5A-D show exemplary graphic user interface gestures in accordance with an exemplary embodiment;

FIG. 6 is a flow diagram of a method in accordance with an exemplary embodiment;

FIG. 7 shows a device incorporating features of an exemplary embodiment;

FIG. 8 is a block diagram of one embodiment of a typical apparatus incorporating features of an exemplary embodiment that may be used to practice the aspects of the disclosed embodiments; and

FIGS. 9A-C show state changes of the graphical user interface in accordance with an exemplary embodiment.

### DETAILED DESCRIPTION OF THE EXEMPLARY EMBODIMENT(S)

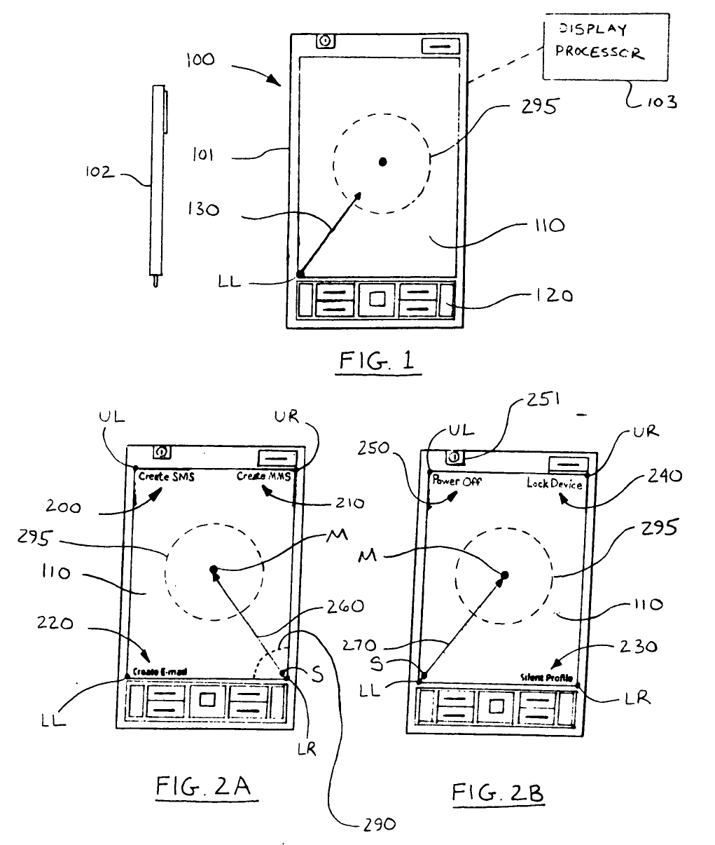

FIG. 1 illustrates one embodiment of a system incorporating features of an embodiment. Although the present embodiments will be described with reference to the exemplary embodiments shown in the drawings and described below, it should be understood that the present invention could be embodied in many alternate forms of embodiments. In addition, any suitable size, shape or type of elements or materials could be used.

FIG. 1 shows a device 100 including a touch screen display 110 and a pointing device 102. The pointing device 102, such as for example, a stylus, pen or simply the user's finger, can be used with the touch screen display 110. In alternate embodiments any suitable pointing device may be used. The display 110 and the pointing device 102 form a user interface of the device 100, which may be configured as a graphical user interface. The device 100 may also include a display processor 103 coupled to a memory that stores a gesture or stroke based algorithm for causing the display processor 103 to operate in accordance with this invention. A first communication or data link or connection may exist between the display 110 and the processor for the processor to receive coordinate information that is descriptive or indicative of the approximate location or area of the tip or end of the pointing device 102 relative to the surface of the display 110. The display 110 is typically pixelated, and may contain liquid crystal (LC) or some other type of display pixels. In alternate embodiments any suitable type of touch enabled display may be utilized.

The display processor 103 may generally provide display data directly or indirectly to the display 110 over, for example, a second communication or data link or connection for activating desired pixels, as is well known in the art. A given coordinate location, such as for example an x-y location on the surface of the display 110 may correspond directly or indirectly to one or more display pixels, depending on the pixel resolution and the resolution of the touch screen itself. A single point on the touch screen display 110 (a single x-y location) may thus correspond to one pixel or to a plurality of adjacent pixels. Differing from a single point, a mark, path, stroke, line or gesture 130 (as these terms are used interchangeably herein) may have a starting x-y point and an ending x-y point, and may include some number of x-y locations between the start and end points. Bringing an end of the pointing device 102 in proximity to or in contact with the surface of the display 110 may indicate a starting point of the mark 130. In this embodiment the mark 130 is shown as having a start point in a region substantially at or near the lower left corner of the display 110. Subsequently moving or lifting the end of the pointing device 102 away from the surface of the display 110 may indicate the end point of the mark 130. In one embodiment, the pointing device 102 does not need to make contact with the surface of the display 110 to cause the formation of, or recognition of, an input signal to form a mark 130.

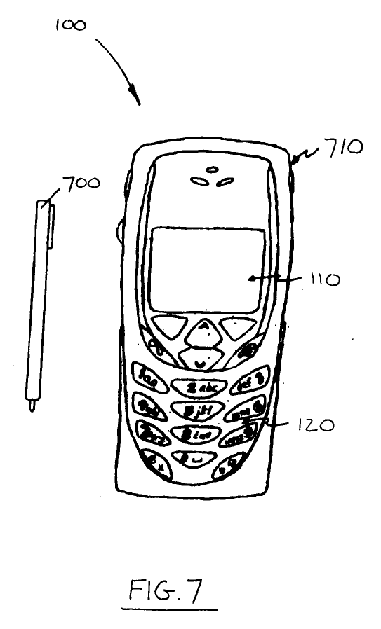

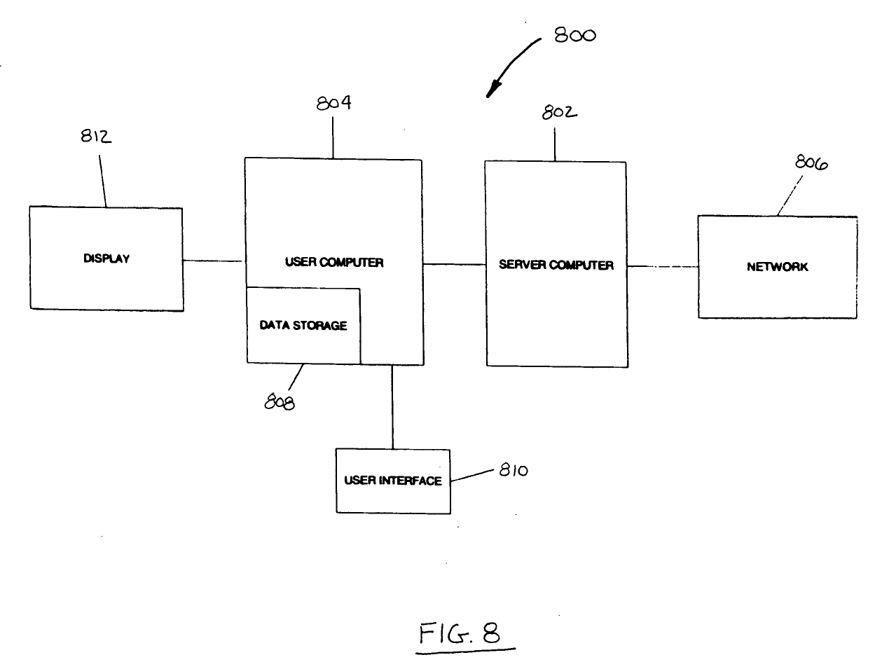

In accordance with one embodiment, the device 100, may be for example, the PDA 101 illustrated in FIG. 1. The PDA 101 may have a keypad 120, a touch screen display 110 and a pointing device 102 for use on the touch screen display 110. In accordance with another embodiment, the device 100 may be the cell phone 710 shown in FIG. 7. The cell phone 710 may also have a touch screen display 110 a keypad 120 and a pointing device 700. In still other alternate embodiments, the device 100 may be a personal communicator, a tablet computer, a laptop or desktop computer, or any other suitable device capable of containing the touch screen display 110 and supported electronics such as, for example, the display processor 103.

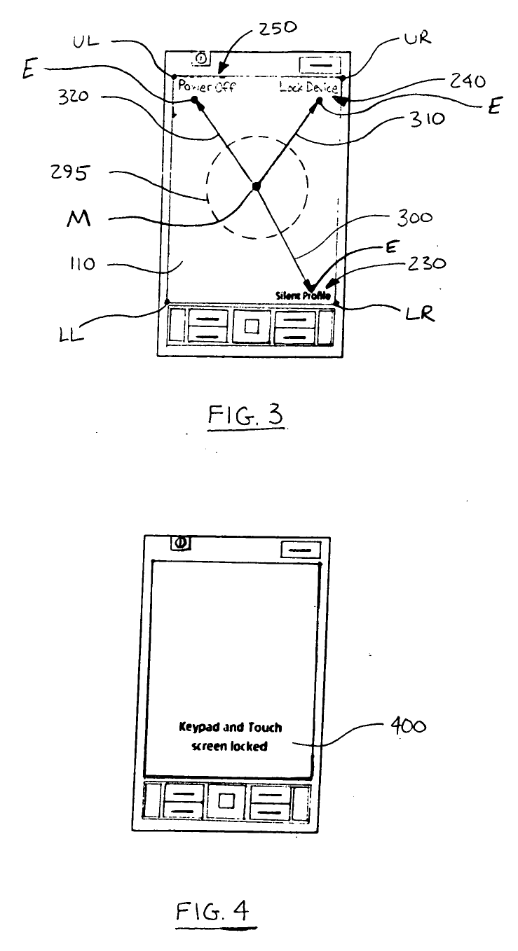

Referring to FIGS. 2A, 2B, 3, and 4 a method for invoking or activating device features using a pointing device in accordance with one embodiment will now be described. The device features may be any suitable device features such as software based applications (e.g. programs) or hardware features including, but not limited to, lights or speakers. The device features may be enabled and activated depending on the starting and ending point of the mark. In the embodiments shown in FIGS. 2A, 2B and 3 the marks 260, 270, 300-320 are shown as having a start point S, an intermediary point M and an end point E. It should be understood that any suitable location for the start point, intermediary point and end point of the mark may be used. The marks may also take any suitable shape or form and are not limited the shapes described herein. In this example, when the pointing device is dragged or moved from, for example, a corner region of touch screen 110 to the center region 295 of the touch screen the user interface of the device changes to show commands to device features in one or more of the other three corners of the touch screen 110. The commands may for example, launch or start a program or activate a hardware feature of the device.

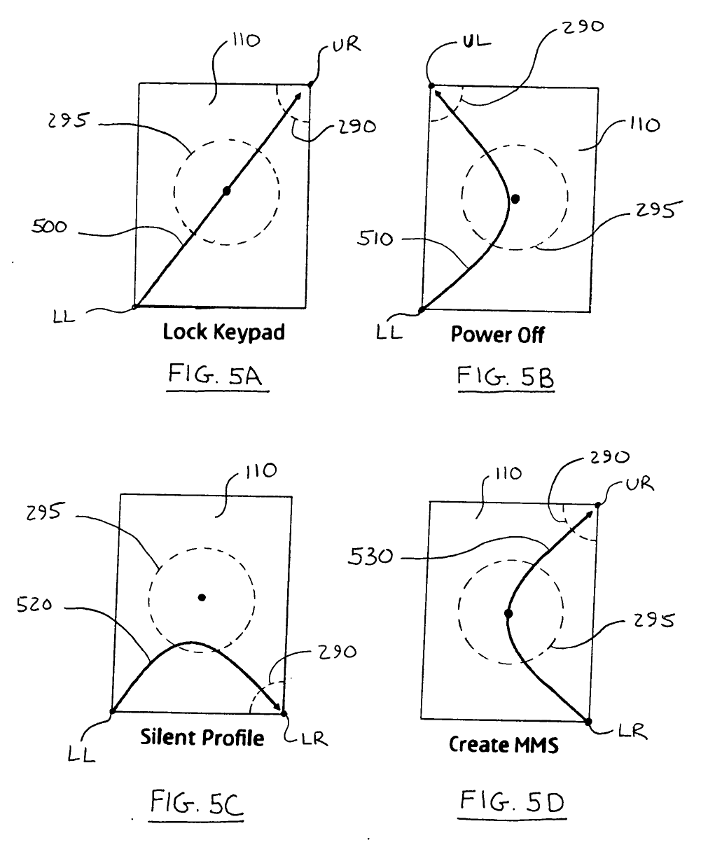

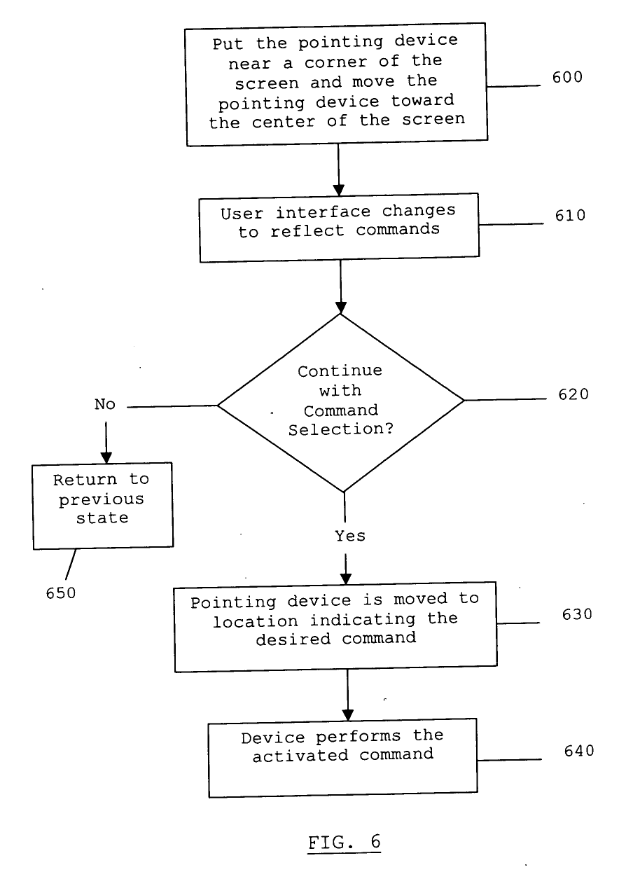

As used herein, the term “corner” is not meant to necessarily define a point, but may also comprise a region 290 (FIGS. 5A-5D) around the location. The regions 290 may allow the user to begin or end the mark at a point near a corner, the center, or any other point on the screen 110, as long as the start and end points are within a region such as the regions 290, 295. As can be seen in FIGS. 5A-5D, the user may substantially start and end the marks 500, 510, 520, 530 in a corner region 290 while passing through the center region 295 of the touch screen 110. The regions 290, 295 may be defined during manufacture of the device 100 or the user of the device 100 may define them. The regions 290, 295 are shown in the Figures as circles but may have any suitable shape such as square or triangular and be of any suitable size.

In alternate embodiments the start point or origin of the mark may be at any suitable location of the touch screen such as, for example, along an edge of the screen. In alternate embodiments the commands may appear at any point along the edges of the touch screen 100 such as for example, at the mid point of an edge or at any other suitable region or point of the screen 110. For example, if the mark begins in a region 290 around the corner LR the commands may appear in corners LL, UR and UL. A user may become familiar with marks associated with the commands through memorization or in some other suitable manner, so that quicker access to the device features may be had in that the user may not have to wait for the command selections to appear or take time to read the commands on the touch screen 110.

The command selection may be activated or initiated when the user forms a mark by placing a pointing device at a corner region 290 of the touch screen 110 and moves the pointing device towards the center region 295 of the touch screen (FIG. 6, Block 600). The pointing device 102 may be moved across the touch screen 110 at any suitable speed to create the mark. The user may begin the mark from any of the four corners LL, LR, UL, UR of the touch screen 110. In alternate embodiments the mark may start at any suitable point or region of the touch screen, such as a region along an edge of the screen. Depending on which of the corners LL, LR, UL, UR the mark originates, different commands may be displayed for selection in at least one of the other three corners of the screen 110. The corners in which the commands are placed may reflect the physical location of the keys whose functions they represent. For example, as shown in FIG. 2B, the “power off” command 250 may be located in the upper left corner UL, which is the corner closest to the power button 251 for the device 100. The commands may also be customizable depending on the user's needs. For example, there may be a command “set up” screen or function of the device 100 that allows a user to select which device function to associate with a respective mark.

As can be seen in FIG. 2A, a mark 260 is made on the touch screen 110 with the pointing device. The mark 260 may have a starting point S in a region 290 at the lower right corner LR of the touch screen and an intermediary point M in the center region 295 of the touch screen 110. When the pointing device reaches the center region 295 of the touch screen 110, the input detection unit and input recognition unit coupled to the display processor 103 may detect and recognize the mark 260. The feature engagement unit, which is also coupled to the display processor, may cause the user interface to change so that one or more possible commands to device features, such as commands 200, 210, 220, may be presented or shown for selection by the user (FIG. 6, Block 610). The command 200 may be for example a command to create an SMS, command 210 may be for example a command to create an MMS and command 220 may be for example a command to create an e-mail. As noted above and as shown in FIG. 2B, if a mark 270 is formed with a start point S, for example, in the lower left corner LL of the touch screen 110 a different set of commands 230, 240, 250 may appear in the other three corners. Command 230 may be for example a command for silent profile, command 240 may be for example a command for locking the device and command 250 may be for example a command for powering off the device. Similarly, if the mark is started in the upper left UL or upper right UR corners a corresponding set of commands may appear in at least one of the other three corners.

The user may terminate the command selection, as will be described below, or the user may continue the command selection (FIG. 6, Block 620). The user may select a command by moving the pointing device from the intermediary point M at, for example, the center region 295 of the touch screen 110 to a corner region 290 containing the desired command (FIG. 6, Block 630). For example, as can be seen in FIG. 3, if the user creates a mark 270 as shown in FIG. 2B, the user can select either of the commands 230, 240 or 250 by continuing the mark 270 via either of the marks 300-320 to the lower right corner LR, the upper right corner UR or the upper left corner UL of the touch screen 110 respectively. The command may be activated when the pointing device reaches the desired corner region 290 and the input detection unit or input recognition unit coupled to the display processor 103 recognizes the mark. When the command, and hence the device feature, is activated the device indicates the requested action has been performed by, for example, displaying a message 400 on the screen 110 (FIG. 6, Block 640). In this example, the message 400 indicates the touch screen 110 and keypad 120 of the device have been locked from use.

In this example the user does not end the stroke or mark (i.e. lift the pointing device off the screen 110) after the pointing device 102 reaches the center region 295. The movement of the pointing device 102 to the center region 295 may be an intermediary point M in forming the mark which indicates to the display processor 103 that commands corresponding to that mark are to be presented on the screen 110 for selection by the user. The selection of the command may be completed when the mark is further formed or extended into the corner region 290 where the desired command is displayed as described above. However, as noted above, a user may terminate the command selection by, for example, lifting the pointing device at any time before the pointing device reaches the corner region containing a command. In alternate embodiments, the user may terminate the command selection by, for example, continuing to work so the pointing device does not reach the corners where the commands are located. Where the command selection is terminated, no activation of a feature is performed and the user interface may return to its previous state (FIG. 6, Block 650).

In alternate embodiments, algorithms within the device may provide for the user lifting the pointing device 102 off the screen 110 when the mark reaches the center region 295 of the screen. Here, the selection of the command may be completed after the pointing device 102 is lifted from the center region 295 of the screen 110 simply by touching a corner region 290 of the screen 110 where the desired command is presented. The command selection may be terminated in this example by providing a time period in which the command is to be selected after the user lifts the pointing device 102 off the touch screen 110 in that after the time period expires the screen 110 returns to its previous state. In alternate embodiments any suitable termination method may be used to terminate the command selection such as for example, using the device 100 in a normal manner as if the shortcut selection was never activated.

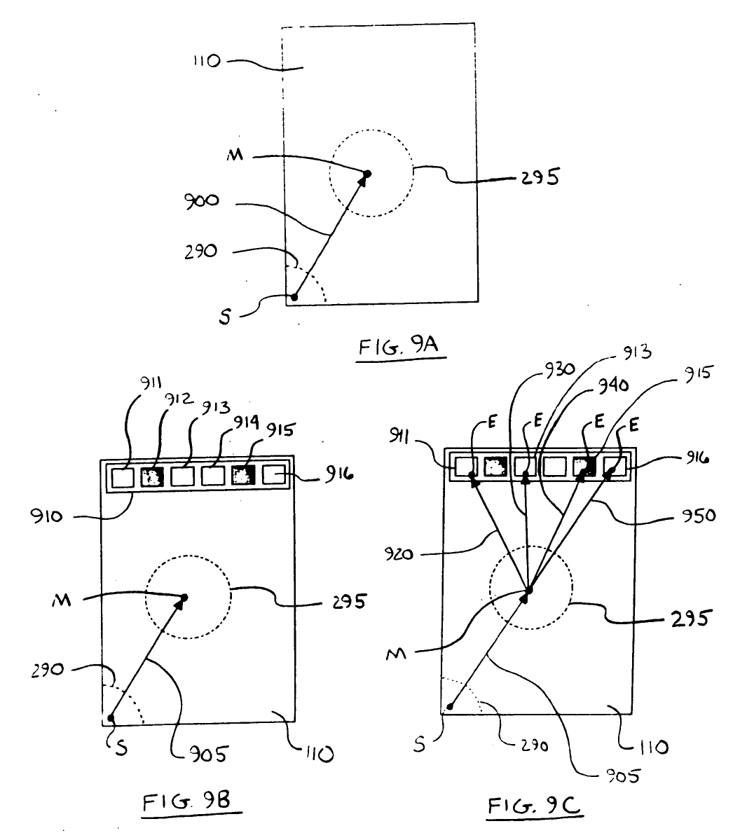

Referring to FIGS. 9A-C and 6 a method for invoking or activating device features in accordance with another embodiment will now be described. As can be seen in FIGS. 9A-C, the marks 900, 905 and 920-950 are shown as having a start point A, and intermediary point M and an end point E. It should be understood that any suitable location for the start point, intermediary point and end point of the mark may be used. The marks are also not limited to the shapes described herein and may take any suitable form. In this example, when the pointing device is dragged or moved from, for example, a corner region 290 of the touch screen 110 to the center region 295 of the touch screen 110 the user interface of the device changes to show, for example, a toolbar 910 along an edge of the touch screen 110. In this example the toolbar is shown along the top of the touch screen 110 but in alternate embodiments, the toolbar may be presented along any suitable edge of the touch screen 110. In other alternate embodiments, more than one toolbar may be presented along different edges of the touch screen 110. The toolbar 910 may contain, for example, commands 911-916 to device features. The commands 911-916 may be similar to those described above in that they may, for example, launch or start a program or activate a hardware feature of the device. In alternate embodiments, the commands 911-916 may be presented along at least one edge of the touch screen without being contained in the toolbar 910.

The toolbar 910 and the command selection may be activated or initiated when the user forms a mark by placing a pointing device at a corner region 290 of the touch screen 110 and moves the pointing device towards the center region 295 of the touch screen 110. As described above, the user may start the mark at any of the four corners of the touch screen 110 or in any suitable region of the touch screen 110. Depending on where the mark originates, different toolbars, which may have different commands, may be displayed for selection along at least one edge of the touch screen. The input detection unit and input recognition unit coupled to the display processor 103 may detect the mark in a substantially similar manner to that described above with respect to the displaying of commands in at least one corner of the touch screen 110. The user may also terminate the command selection in a manner substantially similar to that described above.

The user may select a command 911-916 from the toolbar 910 by moving the pointing device from the intermediary point M at, for example, the center region 295 of the touch screen 110 to a point along the edge of the touch screen where the commands 911-916 are presented for selection. For example as can be seen in FIG. 9C, the user may select either of the commands 911, 913, 915, 916 by continuing the mark 905 via either of the marks 920-950. The command may be activated when the pointing device reaches the desired command 911-916 and the input detection unit or input recognition coupled to the display processor 103 unit recognizes the mark.

The present invention may also include software and computer programs incorporating the process steps and instructions described above that are executed in different computers. FIG. 8 is a block diagram of one embodiment of a typical apparatus 800 incorporating features of the present invention that may be used to practice the present invention. As shown, a computer system 802 may be linked to another computer system 804, such that the computers 802 and 804 are capable of sending information to each other and receiving information from each other. In one embodiment, computer system 802 could include a server computer adapted to communicate with a network 806. Computer systems 802 and 804 can be linked together in any conventional manner including, for example, a modem, hard wire connection, or fiber optic link. Generally, information can be made available to both computer systems 802 and 804 using a communication protocol typically sent over a communication channel or through a dial-up connection on ISDN line. Computers 802 and 804 are generally adapted to utilize program storage devices embodying machine readable program source code which is adapted to cause the computers 802 and 804 to perform the method steps of the present invention. The program storage devices incorporating features of the present invention may be devised, made and used as a component of a machine utilizing optics, magnetic properties and/or electronics to perform the procedures and methods of the present invention. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 802 and 804 may also include a microprocessor for executing stored programs. Computer 802 may include a data storage device 808 on its program storage device for the storage of information and data. The computer program or software incorporating the processes and method steps incorporating features of the present invention may be stored in one or more computers 802 and 804 on an otherwise conventional program storage device. In one embodiment, computers 802 and 804 may include a user interface 810, and a display interface 812 from which features of the present invention can be accessed. The user interface 810 and the display interface 812 can be adapted to allow the input of queries and commands to the system, as well as present the results of the commands and queries.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A method to activate features of a device: comprising:
detecting a mark made by an input device on a touch enabled screen of the device;
displaying at least one command to at least one selectable feature in at least one region of the screen in response to the detection of the mark; and
activating the at least one feature upon detecting that the mark has been extended into the region of the screen where the at least one command is displayed.

2. The method of claim 1, further comprising detecting that the mark originates in a corner region of the screen and extends into a center region of the screen before displaying the at least one command.

3. The method of claim 1, further comprising displaying the at least one command in a corner region of the screen.

4. The method of claim 1, further comprising displaying the at least one command along at least one edge of the screen.

5. The method of claim 1, further comprising detecting that the mark is continuous from its origin to the region of the screen where the at least one command is displayed prior to activating the at least one feature.

6. The method of claim 1, further comprising reverting to a prior configuration of a display on the screen if it is detected that the mark is discontinuous prior to detecting that the mark is extended into the region of the screen where the command is displayed.

7. The method of claim 1, wherein the at least one command displayed on the screen is associated with an origin of the mark.

8. The method of claim 1, wherein the at least one command includes a command for locking the touch screen device, powering off the touch screen device, creating an e-mail, creating an SMS and/or creating an MMS.

9. The method of claim 1, wherein a different one of the at least one command is displayed in each of the at least one region of the screen.

10. A method for activating functions with a pointing device on a device having a touch screen comprising:
placing the pointing device substantially in contact with a touch screen at a first region of the touch screen;
forming a first mark on the touch screen with the pointing device;
automatically displaying at least one feature command of the device upon detection of the first mark;
forming a second mark on the touch screen wherein an end point of the second mark is substantially in a second region of the touch screen; and
automatically activating a selected function upon detection of the end point of the second mark.

11. The method of claim 10, wherein the second mark is continuous with the first mark.

12. The method of claim 10, further comprising displaying the at least one feature command in a corner region of the touch screen.

13. The method of claim 10, further comprising displaying the at least one feature command along at least one edge of the touch screen.

14. The method of claim 10, wherein the first mark is a line extending from a corner region of the touch screen towards a center region of the touch screen.

15. The method of claim 10, wherein the at least one feature command displayed on the touch screen is associated with a respective start point of the first mark.

16. The method of claim 10, wherein the first and second regions correspond to different corner regions of the touch screen.

17. A device comprising:
a display processor;
a touch enabled screen coupled to the display processor;
an input detection unit coupled to the display processor that is configured to receive an input in the form of a mark made by an input device on the touch enabled screen;
an input recognition unit coupled to the display processor that is configured to detect an origin of the mark and an end of the mark; and
a feature engagement unit coupled to the display processor configured to present at least one command to at least one feature on the screen and activate a selected one of the at least one feature.

18. The touch screen device of claim 17, wherein the at least one command is located along at least one edge of the screen.

19. The touch screen device of claim 17, wherein the at least one command is located in a corner region of the screen.

20. The touch screen device of claim 17, wherein the feature engagement unit is configured to display the at least one command on the screen after the mark is extended into a center region of the screen.

21. The touch screen device of claim 17, wherein the at least one command displayed on the screen depends on the origin of the mark.

22. The touch screen device of claim 17, wherein the feature engagement unit is configured to activate the at least one feature when the mark is extended into a region of the screen where the at least one feature is displayed.

23. The touch screen device of claim 22, where the feature engagement unit is configured to not activate the at least one feature if the mark is discontinuous.

24. The touch screen device of claim 22, wherein the device is able to revert to a prior configuration of the screen if the mark is discontinuous.

25. A computer program product comprising:
a computer useable medium having a computer readable code means embodied therein for causing a computer activate a feature of a touch screen device, the computer readable program code means in the computer program product comprising:
computer readable program code means for causing a computer to form a mark as defined with a pointing device on a touch screen, the mark originating in a corner region of the touch screen and passing through a center region of the touch screen;
computer readable program code means for causing the computer to automatically display a at least one command to at least one feature of the device; and
computer readable program code means for causing a computer to activate at least one feature of the device corresponding to a selected one of the at least one command, wherein the selected one of the at least one command is selected by extending the mark into a region of the screen where the at least one command is displayed.

26. The computer program product of claim 25, wherein the at least one command is displayed upon the mark passing through the center region of the screen.

27. The computer program product of claim 25, wherein the at least one command displayed on the screen depends on the origin of the mark.
